(19) United States
(12) Patent Application Publication
(10) Pub. No.: US 2024/0089987 A1
(43) Pub. Date: Mar. 14, 2024

(54) METHODS OF FLEXIBLE TRIGGERING OF APERIODIC SRS

(71) Applicant: NTT DOCOMO, INC., Tokyo (JP)

(72) Inventors: Nadisanka Rupasinghe, Sunnyvale, CA (US); Yuki Matsumura, Tokyo (JP)

(73) Assignee: NTT DOCOMO, INC., Tokyo (JP)

(21) Appl. No.: 18/273,475

(22) PCT Filed: Jan. 21, 2022
(86) PCT No.: PCT/US2022/013387

§ 371 Date: Jul. 20, 2023

Related U.S. Application Data
(60) Provisional application No. 63/140,667, filed on Jan. 22, 2021.

(51) Int. Cl. H04W 72/232; H04L 5/00; H04W 72/0446

(52) U.S. Cl. CPC H04W 72/232; H04L 5/0051; H04W 72/0446

(57) ABSTRACT

A wireless communication method is disclosed that includes receiving, via downlink control information (DCI) or higher layer signaling, configuration information including a parameter and configuring aperiodic Sounding Reference Signal (SRS) (A-SRS) transmission based on the parameter. In other aspects, a terminal and a wireless communication system are also disclosed.

### BACKGROUND

### Technical Field

One or more embodiments disclosed herein relate to mechanism(s) to how aperiodic Sounding Reference Signal (SRS) triggering can be enhanced by introducing additional flexibility.

### Description of Related Art

In 5G new radio (NR) technologies, new requirements are being identified for further enhancing SRS transmission. New items in Rel. 17 relate to, for example, NR Multiple-Input-Multiple-Output (MIMO).

In the new studies being conducted, enhancement of the SRS is targeted for both Frequency Range (FR) 1 and FR2. In particular, study is under way to identify and specify enhancements on aperiodic SRS triggering to facilitate more flexible triggering and/or Downlink Control Information (DCI) overhead/usage reduction.

Additionally, study is under way to specify SRS switching for up to 8 antennas (e.g., xTyR, x={1, 2, 4} and y={6, 8}). Further, studies are evaluating and, if needed, specifying the following mechanism(s) to enhance SRS capacity and/or coverage including SRS time bundling, increased SRS repetition, and/or partial sounding across frequency.

### CITATION LIST

### Non-Patent References

[Non-Patent Reference 1] 3GPP RP 193133, “New WID: Further enhancements on MINI® for NR”, December, 2019.
[Non-Patent Reference 2] 3GPP RANI #103-e, ‘Chairman's Notes’, November, 2020.
[Non-Patent Reference 3] 3GPP TS 38.214, “NR; Physical procedure for data (Release 16).”
[Non-Patent Reference 4] 3GPP TS 38.331, “NR; Radio Resource Control; Protocol specification (Release 15).”

### SUMMARY

One or more embodiments of the present invention provide a wireless communication method that includes receiving, via downlink control information (DCI) or higher layer signaling, configuration information including a parameter and configuring aperiodic Sounding Reference Signal (SRS) (A-SRS) transmission based on the parameter.

In one aspect, if the DCI is received in a slot n, then configuring the aperiodic SRS transmission in an available slot n+t.

In one aspect, tis configured by an offset parameter signaled by the higher layer signaling.

In one aspect, the offset configures a single value for t.

In one aspect, if t is not configured by the higher layer signaling, then t is assumed to be 0.

In one aspect, if t is not configured by the higher layer signaling, then t is configured by the DCI.

In one aspect, the offset configures a list of values for t.

In one aspect, a value of t is selected from the list of values for t by the DCI.

In one aspect, if the value of t is not selected by DCI, then t is assumed to be 0.

In one aspect, a second offset parameter is signaled by the higher layer signaling and the offset and the second offset are configured as one or more combinations.

In one aspect, a combination of the one or more combinations is selected using the DCI.

In one aspect, t is configured for a plurality of A-SRS resources triggered simultaneously by the DCI.

In one aspect, t is configured separately for each of a plurality of A-SRS resources for the configured A-SRS transmission.

In one aspect, t is configured by association with a code point of the DCI.

In one aspect, t is configured explicitly using a DCI field in the DCI.

In one aspect, the DCI is in DCI format 0_1 or DCI format 0_2.

In one aspect, DCI triggers one or more A-SRS resource sets.

In addition, one or more embodiments of the present invention provide a terminal that includes a receiver that receives, via downlink control information (DCI) or higher layer signaling, configuration information including a parameter and a processor that configures aperiodic Sounding Reference Signal (SRS) (A-SRS) transmission based on the parameter.

Further, one or more embodiments provide a wireless communication system that includes a terminal having a receiver that receives, via downlink control information (DCI) or higher layer signaling, configuration information including a parameter and a processor that configures aperiodic Sounding Reference Signal (SRS) (A-SRS) transmission based on the parameter. The system further includes a base station having a transmitter that transmits the configuration information.

Other embodiments and advantages of the present invention will be recognized from the description and figures.

### BRIEF DESCRIPTION OF THE DRAWINGS

FIG. 1 is a diagram showing a schematic configuration of a wireless communications system according to embodiments.

FIG. 2 is a diagram showing a schematic configuration of a UE according to embodiments.

FIG. 3 is a schematic configuration of the UE 10 according to embodiments.

FIG. 4 shows an overview of potential enhancements to aperiodic SRS triggering.

FIG. 5 shows an example information element.

FIG. 6 shows an example information element.

FIG. 7 shows an example of DCI code points.

FIG. 8 shows an example of DCI code points.

FIG. 9 shows an example of DCI code points.

FIG. 10 shows an example of configuring DCI 0_1 and 0_2 for dedicated A-SRS triggering.

FIG. 11 shows an example configuration of t for SRS resource sets of usage ‘Antenna Switching’ with 1T8R Case.

### DETAILED DESCRIPTION

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

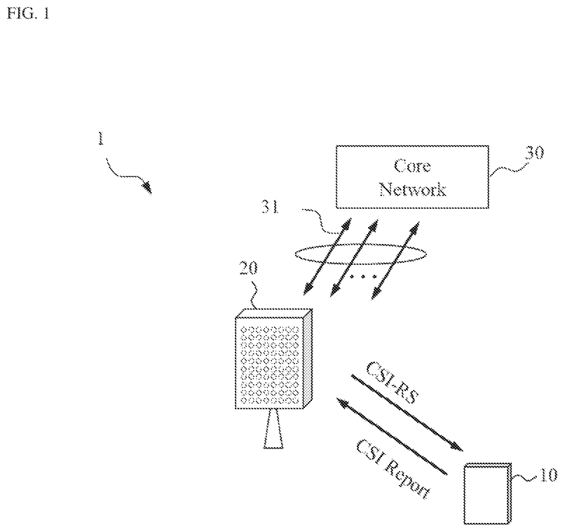

FIG. 1 describes a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). The BS 20 may be referred to as a network (NW) 20.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 1, the BS 20 may transmit a CSI-Reference Signal (CSI-RS) to the UE 10. In response, the UE 10 may transmit a CSI report to the BS 20. Similarly, the UE 10 may transmit SRS to the BS 20.

(Configuration of BS)

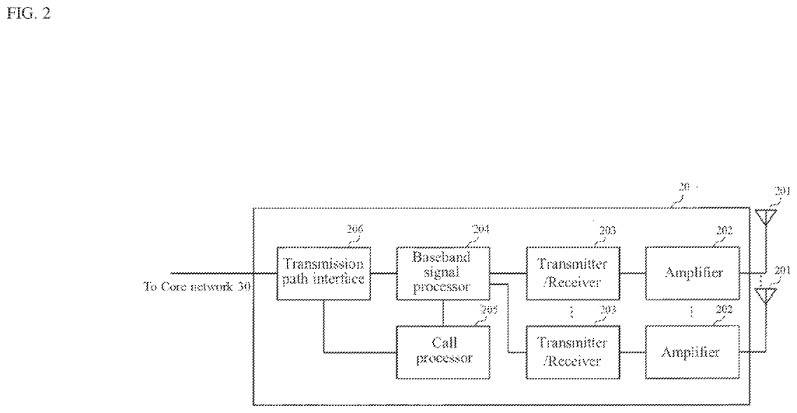

The BS 20 according to embodiments of the present invention will be described below with reference to FIG. 2. FIG. 2 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

(Configuration of UE)

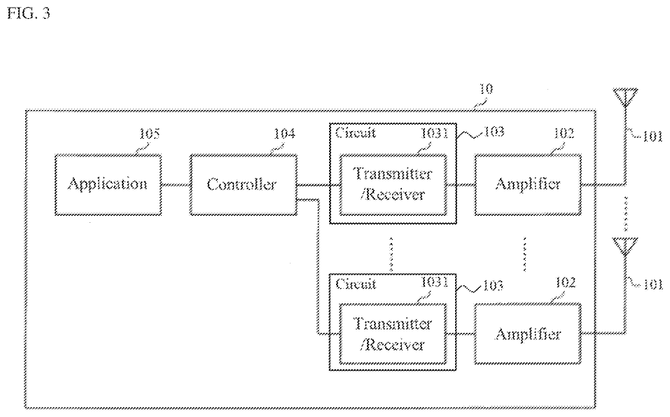

The UE 10 according to embodiments of the present invention will be described below with reference to FIG. 3. FIG. 3 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

One or more embodiments of the present invention with reference to FIG. 4 relate to enhancements for aperiodic SRS triggering. In particular, as noted in [2], possible considerations include the following. A given aperiodic SRS resource set may be transmitted in the (t+1)-th available slot counting from a reference slot, where t is indicated from DCI or RRC (if only one value oft is configured in RRC), and the candidate values oft at least include 0. Further, one or more of following options for the reference slot may be considered. As a one option, the reference slot is the slot with the triggering DCI. As another option, the reference slot is the slot indicated by the legacy triggering offset.

Under consideration as well is the definition of “available slot” considering UE processing complexity and a timeline to determine an available slot as well as potential co-existence with collision handling. Based on only RRC configuration, “available slot” is the slot satisfying: there are UL or flexible symbol(s) for the time-domain location(s) for all the SRS resources in the resource set and it satisfies the minimum timing requirement between triggering PDCCH and all the SRS resources in the resource set.

Also under consideration is explicit or implicit indication of t and whether updating candidate triggering offsets in MAC CE may be beneficial.

As discussed above, studies are under way with regard to the enhancement of SRS. In one or more embodiments described herein may provide how aperiodic SRS triggering can be further enhanced by introducing more flexibility. Flexible A-SRS transmission may be considered from ‘Reference Slot.’

The specifications currently discuss the following:

If the UE receives the DCI triggering aperiodic SRS in slot n and except when SRS is configured with the higher layer parameter SRS-PosResource, the UE transmits aperiodic SRS in each of the triggered SRS resource set(s) in slot

$$\\ ⌊ n \cdot \frac{{2}^{{μ}_{SRS}}}{{2}^{{μ}_{PDCCH}}} ⌋ + k + ⌊ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ⌋ ,$$

if UE is configured with ca-SlotOffset for at least one of the triggered and triggering cell,

$$\\ {K}_{s} = ⌊ n \cdot \frac{{2}^{{μ}_{SRS}}}{{2}^{{μ}_{PDCCH}}} ⌋ + k ,$$

otherwise, and where k is configured via higher layer parameter slotOffset for each triggered SRS resources set and is based on the subcarrier spacing of the triggered SRS transmission, μ_{SRS} and μ_{PDCCH} are the subcarrier spacing configurations for triggered SRS and PDCCH carrying the triggering command respectively; N_{slot,offset,PDCCH}^{CA} and μ_{offset,PDCCH} are the N_{slot,offset}^{CA} and the μ_{offset}, respectively, which are determined by higher-layer configured ca-SlotOffset for the cell receiving the PDCCH, N_{slot,offset,SRS}^{CA} and μ_{offset,SRS} are the N_{slot,offset}^{CA} and the μ_{offset}, respectively, which are determined by higher-layer configured ca-SlotOffset for the cell transmitting the SRS.

One or more embodiments considered herein propose improvements to the aforementioned section of the specifications. In particular, if the UE receives the DCI triggering aperiodic SRS in slot n and except when SRS is configured with the higher layer parameter SRS-PosResource-r16, the UE transmits aperiodic SRS in each of the triggered SRS resource set(s) in an available slot which can occur on or after the slot:

$$\\ ⌊ n \cdot \frac{{2}^{{μ}_{SRS}}}{{2}^{{μ}_{PDCCH}}} ⌋ + t + 1 + ⌊ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ⌋$$

‘Available slot’ is a slot with sufficient UL or flexible symbol(s) for the time-domain location(s) for all SRS resources in the resource set and it satisfies the minimum timing requirement between triggering PDCCH and all the SRS resources in the resource set. It is noted that the term ‘sufficient’ makes sure that the identified ‘Available slot’ contains enough UL or flexible symbol(s) for the time-domain location(s) for all SRS resources within the resource set. It is further noted that t can be configured for each triggered SRS resource set using higher-layer signalling or DCI. Configuration of t is discussed further below in one or more embodiments.

One or more embodiments relate to the configuration of ‘Reference slot.’ As noted above, enhancements to the current specifications are considered. In particular, if the UE receives the DCI triggering aperiodic SRS in slot n and except when SRS is configured with the higher layer parameter SRS-PosResource-r16, the UE transmits aperiodic SRS in each of the triggered SRS resource set(s) in an available slot which can occur on or after the slot:

$$\\ ⌊ n \cdot \frac{{2}^{{μ}_{SRS}}}{{2}^{{μ}_{PDCCH}}} ⌋ + k + ⌊ ( \frac{{N}_{slot , offset , PDCCH}^{CA}}{{2}^{{μ}_{offset , PDCCH}}} - \frac{{N}_{slot , offset , SRS}^{CA}}{{2}^{{μ}_{offset , SRS}}} ) \cdot {2}^{{μ}_{SRS}} ⌋ + t + 1$$

k is configured via higher layer parameter slotOffset for each triggered SRS resources set.

‘Available slot’ is a slot with sufficient UL or flexible symbol(s) for the time-domain location(s) for all SRS resources in the resource set and it satisfies the minimum timing requirement between triggering PDCCH and all the SRS resources in the resource set. It is noted that the term ‘sufficient’ makes sure that the identified ‘Available slot’ contains enough UL or flexible symbol(s) for the time-domain location(s) for all SRS resources within the resource set. It is further noted that the t can be configured for each triggered SRS resource set using higher-layer signalling or DCI. Configuration of t is discussed further below in one or more embodiments.

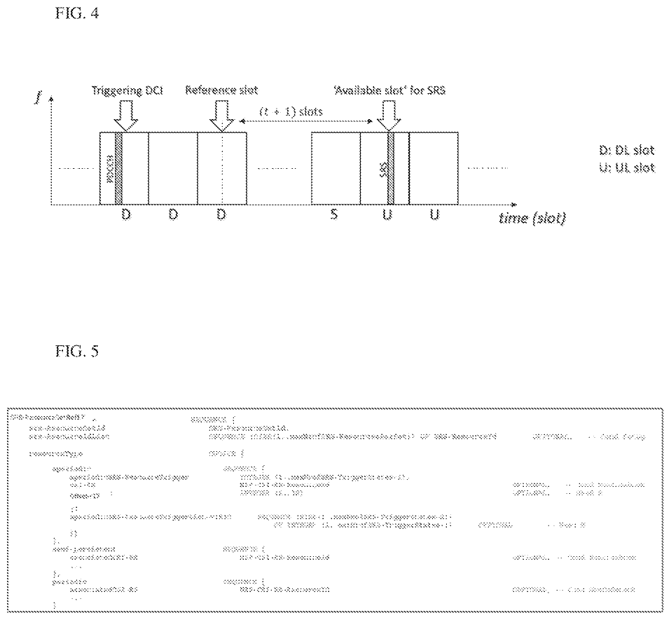

One or more embodiments with reference to FIG. 5 relate to the configuration of the parameter t. The UE is configured with value(s) for t using higher layer signaling or DCI. In particular, following may be considered.

As a first option, RRC signaling may be considered. If ‘Reference slot’ is the slot with the triggering DCI, the example shown in FIG. 5 shows a new RRC IE capturing a new parameter ‘Offset-r17’ which is used to configure t using RRC signaling. Note that the legacy ‘slotOffset’ parameter is removed from the proposed new RRC IE.

One or more of the following options may also be considered. ‘Offset-r17’ configures a single value for t, e.g., Offset-r17=0, then t=0. Alternatively, if the UE is not configured with parameter ‘Offset-r17’, UE assumes t=0. Alternatively, if UE is not configured with parameter ‘Offset-r17’, UE assumes t is configured by DCI.

Alternatively, ‘Offset-r17’ provides a list of values for t. Subsequently, using DCI, the UE can be configured with one value out of those in the list, e.g., Offset-r17∈{0, 1, 4, 6}, then using x=2 bits in DCI (explicit selection), the UE is configured with one value out of those values in the list for t. Using DCI, it is also possible to implicitly select a value from the list. Alternatively, if the UE is not configured with one value out of the values in the list for t using DCI, the UE assumes t=0.

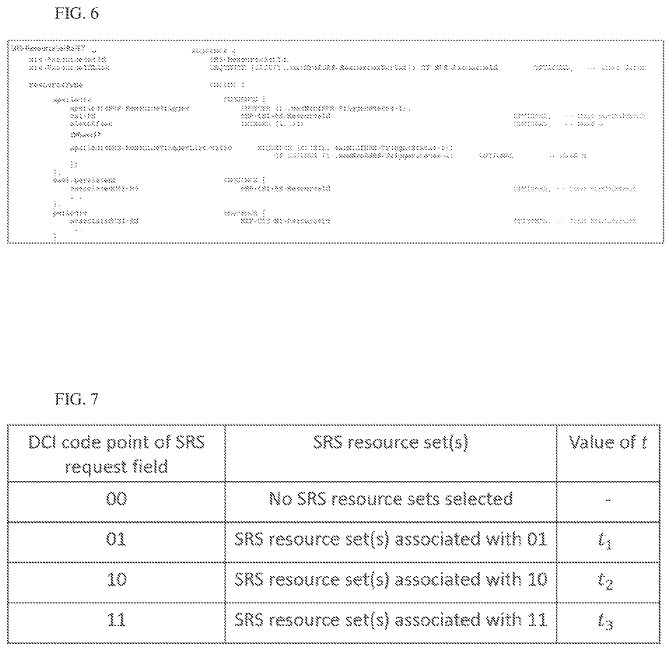

Alternatively, if ‘Reference slot’ is the slot pointed to by the legacy offset, the example shown in FIG. 6 shows a new RRC IE capturing a new parameter ‘Offset-r17,’ which is used to configure t using RRC signaling. Note that, the legacy ‘slotOffset’ parameter also remains within this new RRC IE.

One or more of the following options may also be considered with the alternative example shown in FIG. 6. ‘Offset-r17’ configures a single value for t, e.g., Offset-r17=0, then t=0. Alternatively, if the UE is not configured with parameter ‘Offset-r17’, UE assumes t=0. Alternatively, if UE is not configured with parameter ‘Offset-r17’, UE assumes t is configured by DCI.

Alternatively, ‘Offset-r17’ provides a list of values for t. Subsequently, using DCI, the UE can be configured with one value out of those in the list, e.g., Offset-r17 E {0, 1, 4, 6}, then using x=2 bits in DCI (explicit selection), the UE is configured with one value out of those values in the list for t. Using DCI, it is also possible to implicitly select a value from the list. Alternatively, if the UE is not configured with one value out of the values in the list for t using DCI, the UE assumes t=0.

Alternatively, ‘slotOffset’ and ‘Offset-r17’ are configured as a combination, e.g., if {slotOffset, Offset-r17}={1, 0}, then k=1; t=0. There can be multiple combinations configured by RRC signaling and using DCI one combination out of those is selected.

Additionally, using DCI, the UE may be configured with value(s) for t for each triggered SRS resource set. Note that, the value of t can be implicitly or explicitly captured within the DCI. As an option, the same t is configured to all or some of the A-SRS resource sets triggered simultaneously. As another option, t can be configured separately for some or all of the SRS resources within triggered SRS resource set(s).

Further, if t is not configured by DCI, the UE may consider a value pre-defined in the specification(s), e.g., t=0. The UE may also assume t is configured using higher-layer signaling.

One or more embodiments with reference to FIG. 7 relate to configuration of the parameter t using DCI. The value of t can be implicitly configured by associating it with the DCI code point of the SRS request field of triggering DCI. An example is captured in the table of FIG. 7. Note that, tᵢ, i∈{1, 2, 3} is configured using RRC signaling. The associated RRC parameter for configuring t here is Offset-r17 defined previously.

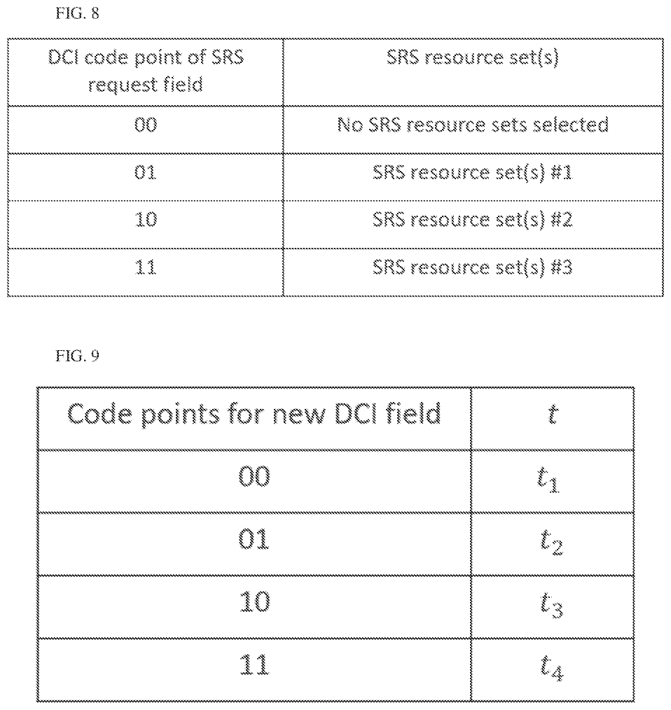

One or more embodiments with reference to FIG. 8 relate to configuration of the parameter t using DCI. Each SRS resource set is associated with a particular t value. Then, by selecting appropriate SRS resource set(s) using DCI code point, the NW can implicitly configure a particular value for parameter t. For example, each SRS resource set in the table shown in FIG. 8 has a particular t value (for example configured using RRC signaling). Then, by selecting a particular SRS resource set from the table, the NW can implicitly configure value for t.

One or more embodiments with reference to FIG. 9 relate to configuration of the parameter t using DCI. In particular, as shown in the table of FIG. 9, using a new DCI field the value of t can be configured explicitly.

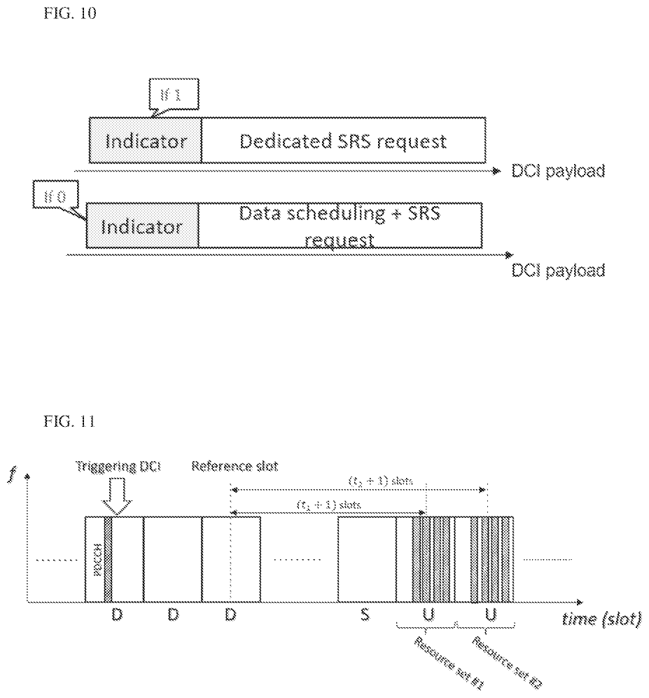

One or more embodiments with reference to FIG. 10 relate to configuring DCI 0_1 and 0_2 for dedicated A-SRS triggering. DCI 0_1 and 0_2 can be used for triggering an A-SRS resource set(s). In order to differentiate between whether this is a dedicated DCI for an SRS request or whether this is for data/CSI scheduling and SRS request (same as Rel. 15 behavior) it may be indicated using an additional one bit as shown in FIG. 10. Note that, the new DCI field indicator only exists when RRC configures it.

One or more embodiments with reference to FIG. 11 relate to configuration of t for SRS resource sets of usage ‘Antenna Switching’ with the 1T8R case. For DL CSI acquisition with 1T8R transceiver architecture, two A-SRS resource sets need to be transmitted in two different slots. For example, as shown in FIG. 11 SRS resource set #1 and set #2 each have 4 SRS resources and are configured for DL CSI acquisition with 1T8R. Here, set #1 and set #2 are configured with t=t₁ and t=t₂, respectively. As an option, the same t is configured using higher layer signaling or DCI for both SRS resource sets. Then, following the ‘available slot’ definition, the UE first transmits set #1 on a first available slot and set #2 on the first available slot right after transmitting set #1.

As another option, the value t̅ is configured using higher layer signaling or DCI. Then, the UE assumes for set #1, t₁=t̅ and for set #2, t₂=t̅+1. Here, t₁ and t₂ are the t parameter associated with set #1 and set #2, respectively. As another option, there may be a separate configuration of t₁ and t₂ for set #1 and set #2. Note that, for DL CSI acquisition with 1T8R case, available slot may refer to a single slot or two consecutive slots.

Variation

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/present embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/present embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations may have the functions of the user terminals described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMES (Mobility Management Entities), S-GW (Serving-Gateways), and so on may be possible, but these are not limiting) other than base stations, or combinations of these.

One or more embodiments illustrated in this specification may be used individually or in combinations, which may be switched depending on the mode of implementation. The order of processes, sequences, flowcharts, and so on that have been used to describe the aspects/present embodiments herein may be re-ordered as long as inconsistencies do not arise. For example, although various methods have been illustrated in this specification with various components of steps in exemplary orders, the specific orders that are illustrated herein are by no means limiting.

One or more embodiments illustrated in the present disclosure may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, assuming, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

Furthermore, the term “or” as used in this specification or in claims is intended to be not an exclusive disjunction.

Now, although the present invention has been described in detail above, it should be obvious to a person skilled in the art that the present invention is by no means limited to the embodiments described in this specification. The present invention can be implemented with various corrections and in various modifications, without departing from the spirit and scope of the invention defined by the recitations of claims. Consequently, the description in this specification is provided only for the purpose of explaining examples, and should by no means be construed to limit the invention according to the present invention in any way.

The above examples and modified examples may be combined with each other, and various features of these examples may be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A wireless communication method, comprising:
receiving, via downlink control information (DCI) or higher layer signaling, configuration information including a parameter; and
configuring aperiodic Sounding Reference Signal (SRS) (A-SRS) transmission based on the parameter.

2. The wireless communication method of claim 1, wherein if the DCI is received in a slot n, then configuring the aperiodic SRS transmission in an available slot n+t.

3. The wireless communication method of claim 2, wherein t is configured by an offset parameter signaled by the higher layer signaling.

4. The wireless communication method of claim 3, wherein the offset configures a single value for t.

5. The wireless communication method of claim 2, wherein if t is not configured by the higher layer signaling, then t is assumed to be 0.

6. The wireless communication method of claim 2, wherein if t is not configured by the higher layer signaling, then t is configured by the DCI.

7. The wireless communication method of claim 3, wherein the offset configures a list of values for t.

8. The wireless communication method of claim 7, wherein a value of t is selected from the list of values for t by the DCI.

9. The wireless communication method of claim 8, wherein if the value of t is not selected by DCI, then t is assumed to be 0.

10. The wireless communication method of claim 3, wherein a second offset parameter is signaled by the higher layer signaling and the offset and the second offset are configured as one or more combinations.

11. The wireless communication method of claim 10, wherein a combination of the one or more combinations is selected using the DCI.

12. The wireless communication method of claim 2, wherein t is configured for a plurality of A-SRS resources triggered simultaneously by the DCI.

13. The wireless communication method of claim 2, wherein t is configured separately for each of a plurality of A-SRS resources for the configured A-SRS transmission.

14. The wireless communication method of claim 2, wherein t is configured by association with a code point of the DCI.

15. The wireless communication method of claim 2, wherein t is configured explicitly using a DCI field in the DCI.

16. The wireless communication method of claim 1, wherein the DCI is in DCI format 0_1 or DCI format 0_2.

17. The wireless communication method of claim 16, wherein DCI triggers one or more A-SRS resource sets.

18. A terminal, comprising:
a receiver that receives, via downlink control information (DCI) or higher layer signaling, configuration information including a parameter; and
a processor that configures aperiodic Sounding Reference Signal (SRS) (A-SRS) transmission based on the parameter.

19. A wireless communication system, comprising:
a terminal comprising:
a receiver that receives, via downlink control information (DCI) or higher layer signaling, configuration information including a parameter; and
a processor that configures aperiodic Sounding Reference Signal (SRS) (A-SRS) transmission based on the parameter; and
a base station comprising:
a transmitter that transmits the configuration information.
